(19) United States
(12) Patent Application Publication
(10) Pub. No.: US 2023/0039449 A1
(43) Pub. Date: Feb. 9, 2023

(54) DISPLAY PANEL

(71) Applicants: SAMSUNG ELECTRONICS CO., LTD., Suwon-si (KR); RESEARCH & BUSINESS FOUNDATION SUNGKYUNKWAN UNIVERSITY, Suwon-si (KR)

(72) Inventors: Jinho KIM, Suwon-si (KR); Yong-Sang KIM, Suwon-si (KR); Donggun OH, Suwon-si (KR); Jongsu OH, Suwon-si (KR)

(73) Assignees: SAMSUNG ELECTRONICS CO., LTD., Suwon-si (KR); RESEARCH & BUSINESS FOUNDATION SUNGKYUNKWAN UNIVERSITY, Suwon-si (KR)

(21) Appl. No.: 17/970,153

(22) Filed: Oct. 20, 2022

Related U.S. Application Data
(63) Continuation of application No. PCT/KR2021/004995, filed on Apr. 21, 2021.

(30) Foreign Application Priority Data
Apr. 24, 2020 (KR) 10-2020-0050317
Oct. 22, 2020 (KR) 10-2020-0137268

(51) Int. Cl. G09G 3/32

(52) U.S. Cl. CPC G09G 3/32; G09G 2320/0633

(57) ABSTRACT

In a display panel, pixels each including a plurality of sub-pixels are arranged in a matrix form, wherein each of the plurality of sub-pixels includes: an inorganic light-emitting element; a constant current generator circuit that provides a driving current to the inorganic light-emitting element on the basis of a constant current generator data voltage; and a PWM circuit for controlling the time for the driving current to flow through the inorganic light-emitting element on the basis of a PWM data voltage, wherein the constant current generator circuit includes a first driving transistor and the PWM circuit includes a second driving transistor, and wherein the constant current generator circuit or the PWM circuit comprises an internal compensation circuit that compensates for electrical characteristics of the first driving transistor and the second driving transistor.

### CROSS-REFERENCE TO RELATED APPLICATIONS

This application is a bypass continuation of International Application No. PCT/KR2021/004995, filed on Apr. 21, 2021, which is based on and claims priority to Korean Patent Applications No. 10-2020-0050317, filed on Apr. 24, 2020, and 10-2020-0137268, filed on Oct. 22, 2020, in the Korean Intellectual Property Office, the disclosures of which are incorporated by reference herein in their entireties.

### TECHNICAL FIELD

This disclosure relates to a display panel. More particularly, the disclosure relates to a display panel in which a self-emitting element forms a sub-pixel.

### BACKGROUND ART

In a related art display panel where an inorganic light-emitting element such as a red light emitting diode (LED), a green LED, and a blue LED (hereinafter, LED refers to an inorganic light-emitting element) is driven as a sub-pixel, a gray scale of a sub-pixel is represented by a pulse amplitude modulation (PAM) driving method.

In this case, depending on a magnitude of a driving current, the wavelength as well as a gray scale of emitted light may change, resulting in decrease in color reproducibility of an image. FIGS. 1A, 1B, and 1C illustrate a wavelength change according to the magnitude of a driving current flowing through a blue LED, a green LED, and a red LED, respectively.

### DISCLOSURE

An objective of the disclosure is to provide a display panel providing improved color reproducibility for an input image signal and a driving method thereof.

Another objective of the disclosure is to provide a display panel comprising a sub-pixel circuit capable of more efficiently and stably driving an inorganic light-emitting element constituting a sub-pixel, and a driving method thereof.

Another objective of the disclosure is to provide a display panel having high pixel density and a driving method thereof.

Embodiments of the disclosure provide a display panel in which pixels each comprising a plurality of sub-pixels are arranged in a matrix form, wherein each of the plurality of sub-pixels includes an inorganic light-emitting element; a constant current generator circuit that provides a driving current to the inorganic light-emitting element based on a constant current generator data voltage; and a pulse width modulation (PWM) circuit for controlling time for the driving current to flow through the inorganic light-emitting element based on a PWM data voltage, the constant current generator circuit and the PWM circuit each may include a driving transistor, and the constant current generator circuit or the PWM circuit may include an internal compensation circuit that compensates for electrical characteristics of the driving transistor included in the constant current generator circuit or the PWM circuit.

In accordance with an aspect of the disclosure, a display panel in which pixels are arranged in a matrix form, wherein each of the pixels includes a plurality of sub-pixels, wherein each of the plurality of sub-pixels includes an inorganic light-emitting element; a constant current generator circuit that provides a driving current to the inorganic light-emitting element based on a constant current generator data voltage; and a pulse width modulation (PWM) circuit for controlling a time for the driving current to flow through the inorganic light-emitting element based on a PWM data voltage, wherein the constant current generator circuit includes a first driving transistor and the PWM circuit includes a second driving transistor, and wherein the constant current generator circuit or the PWM circuit includes an internal compensation circuit that compensates for electrical characteristics of the first driving transistor or the second driving transistor.

The internal compensation circuit may include a first transistor connected between a gate terminal and a drain terminal of the first driving transistor or the second driving transistor; and a second transistor including a drain terminal connected to a source terminal of the first driving transistor or the second driving transistor; and a gate terminal connected to a gate terminal of the first transistor.

The constant current generator circuit may apply, based on the constant current generator data voltage being applied, the constant current generator data voltage to the gate terminal of the first driving transistor, wherein the PWM circuit includes the internal compensation circuit, wherein the PWM circuit applies, based on the PWM data voltage being applied to a source terminal of the second transistor, a compensation voltage to a gate terminal of the second driving transistor, and wherein the compensation voltage includes the PWM data voltage in which a threshold voltage of the second driving transistor is compensated through the internal compensation circuit.

The drain terminal of the second driving transistor may be connected to the gate terminal of the first driving transistor, and the PWM circuit may control a time during which the driving current flows through the inorganic light-emitting element by controlling an on and off of the first driving transistor through an operation of the second driving transistor that is on and off based on the compensation voltage and a linearly-changing sweep voltage.

The constant current generator data voltage may be comprehensively applied to all pixels included in the display panel, and the PWM data voltage may be applied to pixels arranged in the matrix form in an order of row lines.

The constant current generator data voltage may be based on a prestored compensation value for an electric characteristic of the first driving transistor, and may be applied to the pixels arranged in the matrix form in an order of row lines, and the PWM data voltage may be applied to the pixels arranged in the matrix form in the order of row lines.

The prestored compensation value may be a value calculated based on a luminance value for each pixel of the display panel measured based on a test image displayed on the display panel and captured through an image capturing device.

The constant current generator circuit may include the internal compensation circuit, wherein the constant current generator circuit applies, based on the constant current generator data voltage being applied to a source terminal of the second transistor, a compensation voltage to the gate terminal of the first driving transistor, wherein the compensation voltage includes the constant current generator data voltage in which a threshold voltage of the first driving transistor is compensated through the internal compensation circuit, and wherein the PWM circuit applies, based on the PWM data voltage being applied, the applied PWM data voltage to a gate terminal of the second driving transistor.

A drain terminal of the second driving transistor may be connected to the gate terminal of the first driving transistor, wherein the constant current generator circuit provides, to the inorganic light-emitting element, the driving current of a size corresponding to a difference value between a driving voltage applied to the source terminal of the first driving transistor and the compensation voltage, and wherein the PWM circuit controls the time during which the driving current flows through the inorganic light-emitting element by controlling an on and off of the first driving transistor through an operation of the second driving transistor that is on and off based on the PWM data voltage and a linearly-changing sweep voltage.

The constant current generator data voltage may be comprehensively applied to all the pixels included in the display panel, and the PWM data voltage may be applied to the pixels arranged in the matrix form in an order of row lines.

The PWM data voltage may be based on a prestored compensation value for an electric characteristic of the second driving transistor.

The prestored compensation value may be a value calculated based on a luminance value for each pixel of the display panel measured based on a test image displayed on the display panel and captured through an image capturing device.

A pixel density of the display panel may be greater than or equal to 100 pixels per inch.

As described above, according to various embodiments of the disclosure, the wavelength of light emitted from the inorganic light-emitting element included in the display panel may be prevented from being changed according to the gray scale.

A stain or color of the inorganic light-emitting element constituting the display panel may be corrected, and the brightness or color difference between each display panel module may be corrected when the display panel having a large area is formed by combining the display panels in the form of a module.

A display panel having high pixel density may be implemented. Accordingly, a display panel of high quality, small size, and light weight may be possible.

### DESCRIPTION OF DRAWINGS

FIGS. 1A, 1B, and 1C are graphs illustrating a change in wavelength according to the size of a driving current flowing through a blue light emitting diode (LED), a green LED, and a red LED;

FIG. 2 illustrates a pixel structure of a display panel according to an embodiment;

FIG. 3 is a block diagram of a display panel according to an embodiment;

FIG. 4A is a detailed circuit diagram of a sub-pixel circuit according to an embodiment;

FIG. 4B is a timing diagram of various signals to drive a sub-pixel circuit of FIG. 4A according to an embodiment;

FIG. 5 is a circuit diagram of an internal compensation circuit according to an embodiment;

FIG. 6 is a diagram illustrating a problem related to pixel density;

FIG. 7A is a detailed circuit diagram of a sub-pixel circuit according to an embodiment of the disclosure;

FIG. 7B is a timing diagram of various signals to drive a sub-pixel circuit of FIG. 7A according to an embodiment;

FIG. 8A is a detailed circuit diagram of a sub-pixel circuit according to an embodiment;

FIG. 8B is a timing diagram of various signals to drive a sub-pixel circuit of FIG. 8A according to an embodiment;

FIG. 9A is a detailed circuit diagram of a sub-pixel circuit according to an embodiment of the disclosure;

FIG. 9B is a timing diagram of various signals to drive a sub-pixel circuit of FIG. 9A according to an embodiment;

FIG. 10 is a configuration diagram of a display device according to an embodiment;

FIG. 11A is a cross-sectional diagram of a display panel according to an embodiment; and

FIG. 11B is a cross-sectional diagram of a display panel according to an embodiment.

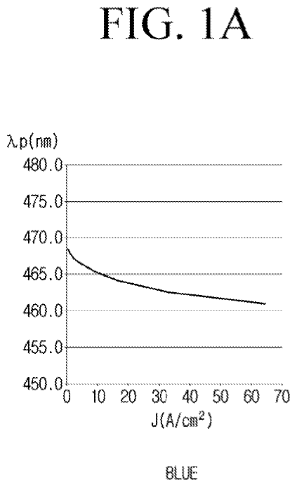

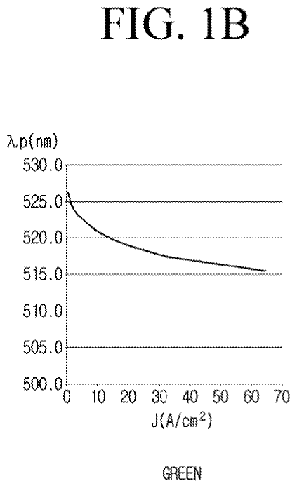

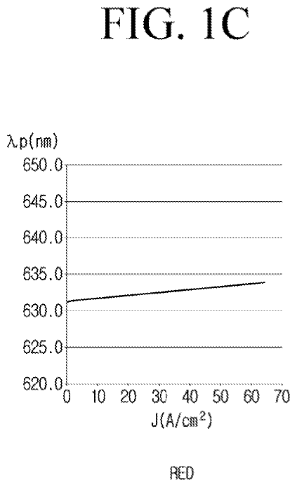

In the disclosure, detailed descriptions of related art techniques are omitted when it is determined that such descriptions may unnecessarily obscure the gist of the disclosure. In addition, the duplicate description of the same configuration of the disclosure will be omitted.

The suffix “part” for a component used in the description of the disclosure is added or used in consideration of the convenience of the specification, and it is not intended to have a meaning or role that is distinct from each other.

The terminology used in this disclosure is used to describe an embodiment, and is not intended to restrict and/or limit the disclosure. A singular expression includes plural expressions unless the context clearly indicates otherwise.

It is to be understood that the terms such as “comprise”, “include” or “have” may, for example, be used to designate a presence of a characteristic, number, step, operation, element, component, or a combination thereof, and not to preclude a presence or a possibility of adding one or more of other characteristics, numbers, steps, operations, elements, components or a combination thereof.

In the disclosure, the terms “first, second, etc.” may be used to describe various elements regardless of their order and/or importance and to discriminate one element from other elements, but are not limited to the corresponding elements.

If it is described that an element (e.g., first element) is “operatively or communicatively coupled with/to” or is “connected to” another element (e.g., second element), it may be understood that the element may be connected to the other element directly or through still another element (e.g., third element).

If it is described that a certain element (e.g., first element) is “connected to” another element (e.g., second element), it should be understood that the first element may be directly connected to the second element or may be connected to the second element through still another element (e.g., third element).

The terms used in embodiments of the disclosure may be interpreted in a meaning commonly known to those of ordinary skill in the art unless otherwise defined.

Various embodiments of the disclosure will be described in detail with reference to the accompanying drawings.

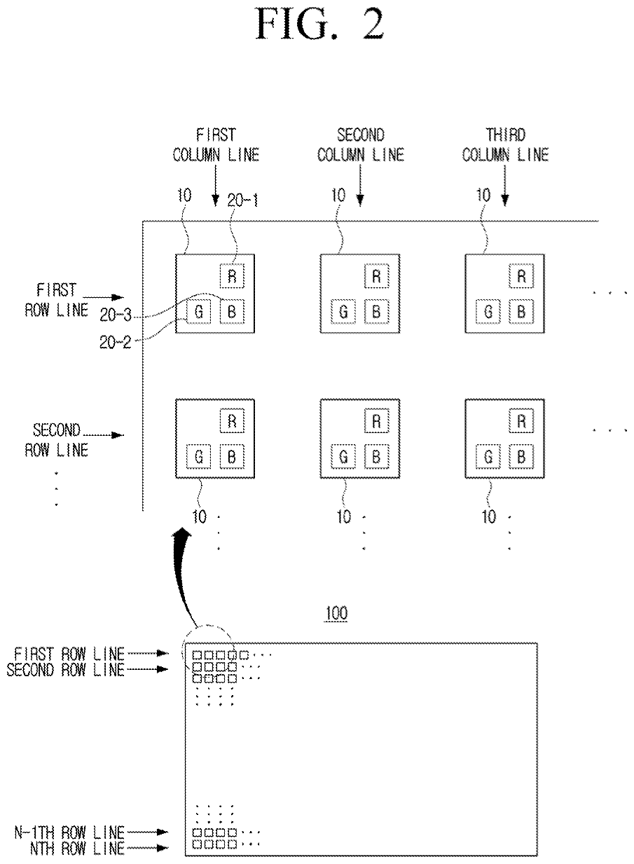

FIG. 2 illustrates a pixel structure of a display panel according to an embodiment.

Referring to FIG. 2, a display panel 100 includes a plurality of pixels 10 disposed or arranged in a matrix form, that is, a pixel array.

The pixel array includes a plurality of row lines or a plurality of column lines. The row line may also be called a horizontal line, a scan line, or a gate line, and the column line may also be called a vertical line or a data line.

A term such as a row line, a column line, a horizontal line, and a vertical line may be used to refer to a line on a pixel array, and the term scan line, gate line, and data line may be used to refer to the actual line on the display panel 100 to which data or signals are transmitted.

Each pixel 10 of the pixel array includes a plurality of inorganic light-emitting elements 20-1, 20-2, and 20-3 of different colors constituting the sub-pixels of the corresponding pixel. For example, as shown in FIG. 2, each pixel 10 may include three types of inorganic light-emitting elements, such as red (R) inorganic light-emitting element 20-1, green (G) inorganic light-emitting element 20-2, and blue (B) inorganic light-emitting element 20-3.

The inorganic light-emitting element may refer to a light-emitting element that is manufactured using an inorganic material which is different from an organic light emitting diode (OLED) manufactured using an organic material.

According to an embodiment, the inorganic light-emitting element may be a micro light emitting diode (micro LED or μLED) having a size that is less than or equal to 100 micrometers (μm). The display panel 100 is a micro LED display panel in which each sub-pixel is implemented with the micro LED.

The micro LED display panel is one of a flat display panel and may include a plurality of inorganic light emitting diodes, each of which is less than or equal to 100 micrometers. The micro LED display panel may provide better contrast, response time, and energy efficiency compared to a liquid crystal display (LCD) panel requiring backlight. The organic light emitting diode (OLED) and the micro LED have good energy efficiency, but the micro LED may provide better performance than the OLED in terms of brightness, light emission efficiency, and operating life.

According to various embodiments, an inorganic light-emitting element is not necessarily limited to a micro LED.

A sub-pixel circuit for driving an inorganic light-emitting element may be provided for each sub-pixel in the display panel 100. The sub-pixel circuit may control the magnitude and duration of the driving current provided to the inorganic light-emitting element based on the data voltage applied from the data driver.

In detail, the sub-pixel circuit may include a constant current generator circuit for driving the inorganic light-emitting element based on pulse amplitude modulation (PAM) by controlling the magnitude of the driving current based on the constant current generator data voltage, and a PWM circuit for driving the inorganic light-emitting element based on pulse width modulation (PWM) by controlling the duration of the driving current based on the PWM data voltage.

In particular, when the inorganic light-emitting element 110 is driven by the PWM driving method, the duration time of the driving current may be varied, and various gray levels may be expressed by varying the duration of the driving current. Therefore, according to various embodiments of the disclosure, the wavelength of the light emitted by the LED light (specifically, the micro LED light) is changed according to the gray scale, which is a problem that may occur when driving the LED with only a PAM method.

Referring to FIG. 2, the sub-pixels 20-1 to 20-3 are arranged in an L-shape in which left and right of the sub-pixels 20-1 to 20-3 are changed in one pixel 10. However, an arrangement shape of the R, G, and B sub-pixels 20-1 to 20-3 is merely an example, and the pixels may be arranged in various shapes according to an embodiment.

Referring to the above example, three different types of inorganic light-emitting elements may form one pixel. However, according to an embodiment, four kinds of sub-pixels such as R, G, B, and white (W) may form one pixel, and any other number of sub-pixels may form one pixel. In this case, since the W inorganic light-emitting element is used in the luminance representation of the pixel, power consumption may be reduced compared to the pixel consisting of inorganic light-emitting elements of three types of R, G, and B. For convenience, a case where the pixel 10 is composed of three types of sub-pixels such as R, G, and B will be described.

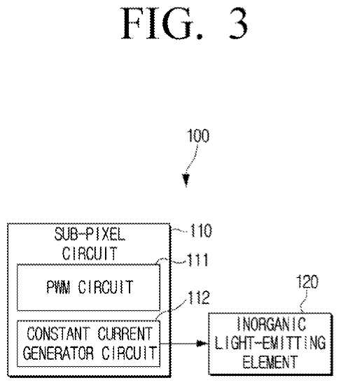

FIG. 3 is a block diagram of another display panel according to an embodiment of the disclosure. In FIG. 3, only one sub-pixel related configuration is shown, for convenience. Referring to FIG. 3, the display panel 1000 may include an inorganic light-emitting element 120, a constant current generator circuit 112, and a PWM circuit 111.

As described above, the constant current generator circuit 112 and the PWM circuit 111 are provided for each sub-pixel, and they may together be referred to as the sub-pixel circuit 110.

The inorganic light-emitting element 120 includes sub-pixels 20-1 to 20-3 of the display panel 100, and may emit light based on the driving current provided from the sub-pixel circuit 110.

The inorganic light-emitting element 120 may have a plurality of types according to the color of light emitted from the light-emitting element 120. For example, the inorganic light-emitting element 120 may include a red (R) inorganic light-emitting element emitting light of a red color, a green (G) inorganic light-emitting element emitting light of a green color, and a blue (B) inorganic light-emitting element emitting light of a blue color, and the type of the sub pixel may be determined according to the type of the inorganic light-emitting element 120.

The inorganic light-emitting element 120 may represent a grayscale value of different brightness depending on the magnitude of the driving current provided from the sub-pixel circuit 110 or the pulse width of the driving current. The pulse width of the driving current may be called a duty ratio of the driving current or the duration of the driving current.

For example, the inorganic light-emitting element 120 may express a brighter gray scale value as the magnitude of the driving current is increased. The inorganic light-emitting element 120 may express a brighter gray scale as the pulse width of the driving current increases (e.g., the duty ratio of the driving current increases or the duration of the driving current increases).

The sub-pixel circuit 110 may provide a driving current to the inorganic light-emitting element 120. The sub-pixel circuit 110 may provide a driving current with controlled magnitude and duration to the inorganic light-emitting element 120 based on a data voltage (e.g., a constant current generator voltage, a PWM data voltage), a driving voltage (e.g., VDD_CCG, VDD_PWM), and various control signals applied from the driver (for example, data driver, gate driver, etc.).

The sub-pixel circuit 110 may drive the inorganic light-emitting element 120 by PAM and PWM driving, to control brightness of light emitted by the inorganic light-emitting element 120.

The sub-pixel circuit 110 may include a constant current generator circuit 112 for providing a constant current of a constant magnitude to the inorganic light-emitting element 120 based on the applied constant current data voltage, and the PWM circuit 111 for providing the constant current to the inorganic light-emitting element 120 for a time corresponding to the applied PWM data voltage. The constant current provided to the inorganic light-emitting element 120 becomes the driving current.

As described above, according to an embodiment of the disclosure, since the inorganic light-emitting element is PWM-driven to represent a gray level, a problem in which the wavelength of the light emitted by the inorganic light-emitting element is changed according to the gray level may be solved when the inorganic light-emitting element is driven by only the PAM method.

The constant current generator circuit 112 and the PWM circuit 111 each include a driving transistor. The driving transistor is a core configuration to determine the operation of the constant current generator circuit 112 or the PWM circuit 111. In theory, an electrical characteristic, such as the threshold voltage Vth of the driving transistor or the mobility needs to be the same among the sub-pixel circuits of the display panel 100.

However, the threshold voltage Vth and mobility μ of the actual driving transistor may be different for each pixel circuit due to various factors such as a process deviation or a time change, and this deviation may be compensated for to prevent the deterioration of image quality.

Hereinafter, sub-pixel circuits according to various embodiments are disclosed that may compensate the deviation of electric features between driving transistors while driving the inorganic light-emitting elements based on PWM method.

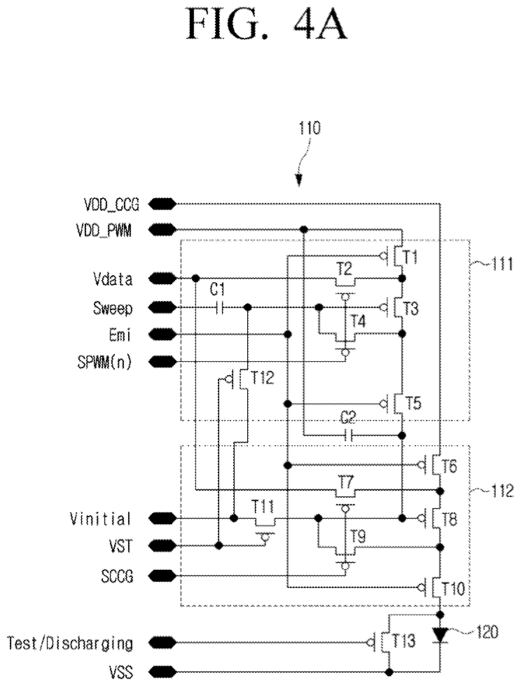

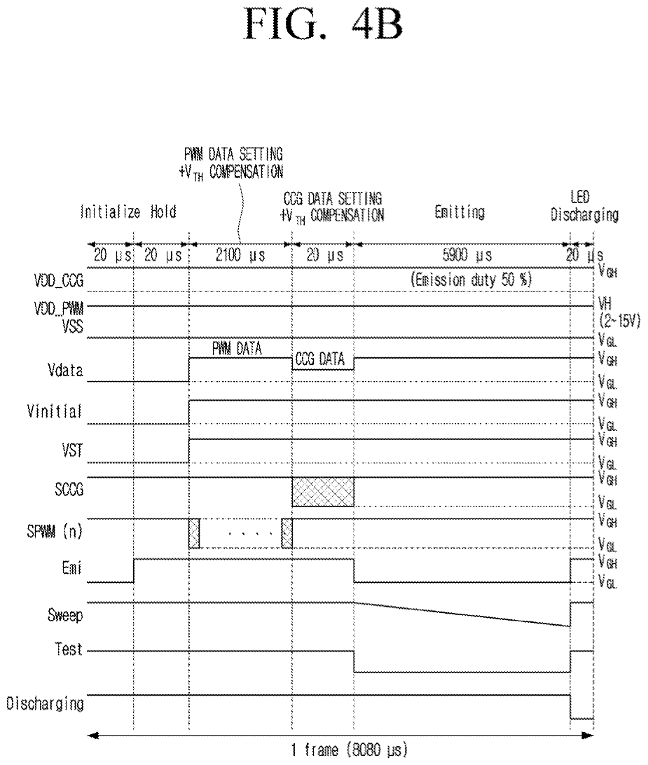

FIG. 4A is a detailed circuit diagram of a sub-pixel circuit 110 according to an embodiment of the disclosure. FIG. 4A illustrates one sub-pixel related circuit, that is, one inorganic light-emitting element 120 and the sub-pixel circuit 110 for driving the one inorganic light-emitting element 120. The display panel 100 may be provided with the inorganic light-emitting element 120 and the sub-pixel circuit 110 for each sub-pixel, as shown in FIG. 4A. The inorganic light-emitting element 120 may be an LED of any one of R, G, and B colors.

Referring to FIG. 4A, the sub-pixel circuit 110 may include the constant current generator circuit 112 and the PWM circuit 111.

The constant current generator circuit 112 includes a driving transistor T8. When the constant current generator data voltage is applied through the source terminal of the transistor T7 while the transistors T9 and T7 are turned on according to the control signal SCCG, the constant current generator circuit 112 applies a voltage corresponding to the sum of the constant current generator data voltage and the threshold voltage of the driving transistor T8 to the gate terminal of the driving transistor T8 through the turned-on driving transistor T8 and the transistor T9.

The constant current generator data voltage may be a voltage within a voltage range of less than a sum of the driving voltage VDD_CCG and the threshold voltage Vth of the driving transistor T8. The driving transistor T8 maintains the ON state while the constant current generator data voltage is set to the gate terminal of the driving transistor T8.

The PWM circuit 111 includes a driving transistor T3. When the PWM data voltage is applied through the source terminal of the transistor T2 while the transistors T4 and T2 are turned on according to the control signal SPWM(n), a voltage corresponding to the sum of the PWM data voltage and the threshold voltage of the driving transistor T3 is applied to the gate terminal of the driving transistor T3 through the turned-on driving transistor T3 and the transistor T4.

The PWM data voltage may be a voltage within a voltage range of at least a sum of the driving voltage VDD_PWM and the threshold voltage Vth of the driving transistor T3. The driving transistor T3 maintains an off state in a state where the PWM data voltage is set to the gate terminal of the driving transistor T3, except that the PWM data voltage is a voltage corresponding to the full black gray level.

The transistor T1 is turned on and off according to a control signal Emi to connect or disconnect the driving voltage VDD_PWM to or from the PWM circuit 111.

The transistor T5 and the transistor T6 are turned on and off according to a control signal Emi and electrically connect or disconnect the PWM circuit 111 to or from the constant current generator circuit 112.

The transistor T10 is turned on and off according to a control signal Emi and electrically connects or disconnects the constant current generator circuit 112 to or from the inorganic light-emitting element 120.

The capacitor C1 receives sweep voltage (Sweep) which is a voltage sweeping between two different voltages.

The transistor T11 and the transistor 12 are turned on according to the control signal VST and may apply the initial voltage Vinitial to each gate terminal of the driving transistor T8 and the driving transistor T3.

The transistor T13 is connected between the anode terminal and the cathode terminal of the inorganic light-emitting element 120. The transistor T13 is turned on according to a control signal Test to check whether the sub-pixel circuit 110 is abnormal before the inorganic light-emitting element 120 is electrically connected to the sub-pixel circuit 110, and is turned on according to a control signal Discharging to discharge the charge remaining on the inorganic light-emitting element 120 after the inorganic light-emitting element 120 is electrically connected to the sub-pixel circuit 110.

The cathode terminal of the inorganic light-emitting element 120 is connected to the ground voltage VSS terminal.

FIG. 4B is a timing diagram of various signals for driving the sub-pixel circuit of FIG. 4A according to an embodiment of the disclosure. Referring to FIG. 4B, the sub-pixel circuit 110 may be driven in the order of an initialization period (Initialize), a holding period (Hold), a data voltage setting and threshold voltage compensation period, an emitting period (Emitting), and a discharging period (LED Discharging), for one image frame time.

As shown in FIG. 4B, the data voltage setting and threshold voltage compensation period may include PWM data voltage setting and a threshold voltage compensation period (PWM data setting+Vth compensation) of the driving transistor T3 and constant current generator (CCG) data voltage setting and a threshold voltage compensation period (CCG data setting+Vth compensation) of the driving transistor T8.

The initialization period is a period for initializing the gate terminal voltage of the driving transistors T8 and T3. The sub-pixel circuit 110 initializes the gate terminal voltage of the driving transistors T8 and T3 to an initial voltage Vinitial in the initialization period.

The hold period is for maintaining the gate terminal voltage of the driving transistors T8 and T3 in a low state (e.g., initialized state). This is because the driving transistors T8 and T3 must be turned on when the data voltage setting and the threshold voltage Vth compensation period start.

The data voltage setting and threshold voltage compensation period is a period for setting the PWM data voltage and the constant current generator data voltage to the PWM circuit 111 and the constant current generator circuit 112, respectively, and compensating for the threshold voltage Vth of the driving transistors T8 and T3.

According to an embodiment of the disclosure, as shown in FIG. 4B, PWM data voltage setting and threshold voltage compensation of the driving transistor T3 may be performed first, and then constant current generator data voltage setting and threshold voltage compensation of the driving transistor T8 may be performed. However, the order may be changed according to an embodiment.

During the data voltage setting and the threshold voltage compensation period, the transistors T1, T5, T6, and T10 are turned off according to the control signal Emi, so that the constant current generator circuit 112 and the PWM circuit 111 are subject to the data voltage setting and the threshold voltage compensation in an independent state.

The control signal SPWM(n) and the control signal SCCG may be signals output from at least one gate driver circuit implemented inside or outside the display panel 100. In SPWM(n), n denotes the number of row lines of the display panel 100.

As shown in FIG. 4B, the control signal SCCG may be applied collectively to all pixels (or all sub-pixels) included in the display panel 100, unlike the control signal SPWM(n). In the embodiment of FIGS. 4A and 4B, the constant current generator data voltage may be applied collectively to all pixels (or sub-pixels) included in the display panel 100. In this case, the constant current generator data voltage applied to each pixel may be the voltage of the same magnitude for each sub-pixel, but is not limited thereto.

In the data voltage setting and threshold voltage compensation period, the driving transistor T3 maintains the state in which the PWM data voltage (specifically, the voltage corresponding to the sum of the PWM data voltage and the threshold voltage Vth of the driving transistor T3) is set to the gate terminal, and the driving transistor T8 maintains the turned-on state when the constant current generator data voltage (specifically, the voltage corresponding to the sum of the constant current generator data voltage and the threshold voltage Vth of the driving transistor T8) is set to the gate terminal.

The Emitting period is a period in which the inorganic light-emitting element 120 emits light. During the light-emitting period, the inorganic light-emitting element 120 emits light according to the magnitude and duration of the driving current provided by the sub-pixel circuit 110.

In detail, since the transistors T1, T5, T6 and T10 are turned on according to the control signal Emi during the emitting period, the constant current generator circuit 112 and the PWM circuit 111 are electrically connected to each other.

When the emitting period starts, the driving voltage VDD_CCG is applied to the inorganic light-emitting element 120 through the turned-on transistors T6 and T8 according to the control signal Emi and the turned-on driving transistor T8.

Accordingly, when the emitting period starts, the driving current flows through the inorganic light-emitting element 120, and the inorganic light-emitting element 120 starts emitting light. At this time, the driving current for emitting the inorganic light-emitting element 120 has a magnitude corresponding to the constant current generator data voltage.

A sweep voltage Sweep that linearly increases between two different voltages is coupled through the capacitor C1 and is applied to the gate terminal of the driving transistor T3. Therefore, the voltage of the gate terminal of the driving transistor T3 varies according to the sweep voltage.

When the voltage between the source terminal of the driving transistor T3 and the gate terminal reaches the threshold voltage of the driving transistor T3, the driving transistor T3 becomes a turned-on state from the turned-off state.

If the driving transistor T3 is turned on, the driving voltage VDD_PWM is transferred to the gate terminal of the driving transistor T8 through the transistors T1, T5 turned on according to the control signal Emi and the turned-on driving transistor T3.

When the driving voltage VDD_PWM is applied to the gate terminal of the driving transistor T8, the driving transistor T8 is turned off, and the driving current does not flow through the inorganic light-emitting element 120, thereby terminating the emission of the inorganic light-emitting element 120.

As described above, the PWM circuit 111 may PWM-drive the inorganic light-emitting element 120 by controlling the driving current of the inorganic light-emitting element 120, that is, the duration of the driving current based on the PWM data voltage.

There may be a charge remaining on the inorganic light-emitting element 120 even when light emission of the inorganic light-emitting element 120 has been terminated. This may cause a problem that the inorganic light-emitting element 120 emits light after the light emission is finished, which may be particularly problematic when expressing a low gray level (e.g., black).

The LED Discharging period is a period in which the charges remain on the inorganic light-emitting element 120 after the light-emitting period has ended, and the sub-pixel circuit 110 may turn on the transistor T13 according to a control signal Discharging, thereby completely discharging the charge remaining on the inorganic light-emitting element 120 to the ground voltage VSS terminal, thereby solving the problem described above.

The transistor T13 may be used to check whether the sub-pixel circuit 110 is abnormal before the inorganic light-emitting element 120 is electrically connected to the sub-pixel circuit 110. For example, a developer or manufacturer of the product may check the current flowing through the transistor T13 after turning on the transistor T13 during the light emitting period, thereby checking whether the sub-pixel circuit 110 is abnormal (e.g., a short or open of a circuit).

As described above with reference to FIGS. 4A and 4B, according to an embodiment of the disclosure, the sub-pixel circuit 110 may compensate for the threshold voltage deviation of the driving transistors T3 and T8 while PWM-driving the inorganic light-emitting element.

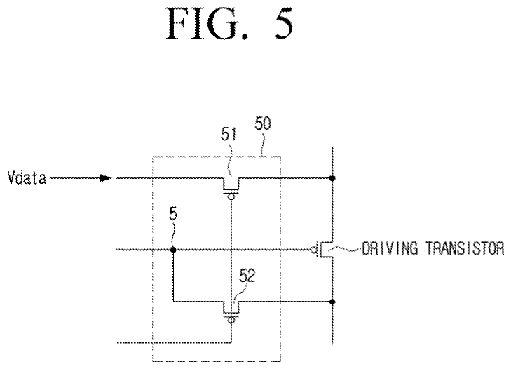

Hereinafter, an operation of the threshold voltage deviation compensation of the driving transistors T3 and T8 will be described in detail with reference to FIG. 5.

FIG. 5 is a circuit diagram of an internal compensation circuit according to an embodiment of the disclosure. Referring to FIG. 5, the internal compensation circuit 50 includes a transistor 51 and a transistor 52. The transistor 52 is connected between the gate terminal 5 and the drain terminal of the driving transistor, and the transistor 51 has a structure in which the drain terminal is connected to the source terminal of the driving transistor, and the gate terminal is connected to the gate terminal of the transistor 52.

Referring to FIG. 4A, the PWM circuit 111 and the constant current generator circuit 112 each include internal compensation circuits for compensating the threshold voltage of the driving transistors T3 and T8 (e.g., by applying a compensation voltage).

Specifically, the PWM circuit 111 includes a transistor T4 connected between a gate terminal and a drain terminal of the driving transistor T3, and a transistor T2 having a drain terminal connected to a source terminal of the driving transistor T3 and a gate terminal connected to a gate terminal of the transistor T4.

In addition, the constant current generator circuit 112 includes a transistor T9 connected between a gate terminal and a drain terminal of the driving transistor T8, and a transistor T7 having a drain terminal connected to a source terminal of the driving transistor T8 and a gate terminal connected to a gate terminal of the transistor T9.

Since the configuration and operation the internal compensation circuit of the PWM circuit 111 and the configuration and operation of the internal compensation circuit of the constant current generator circuit 112 are similar, it will be described below that the internal compensation circuit 50 shown in FIG. 5 is an internal compensation circuit of the constant current generator circuit 112.

When the constant current generator data voltage is applied, the internal compensation circuit 50 applies a voltage corresponding to the sum of the applied constant current generator data voltage and the threshold voltage of the driving transistor T8 to the gate terminal 5 of the driving transistor T8 to compensate for the threshold voltage of the driving transistor T8.

The internal compensation circuit 50 includes transistor 52 (corresponding to transistor T9) connected between the gate terminal 5 and the driving transistor T8 and the transistor 51 (corresponding to transistor T7) in which the drain terminal is connected to the source terminal of the driving transistor T8 and the gate terminal connected to the gate terminal of the transistor 52, as shown in FIG. 5.

In detail, when the transistors T7 and T9 are turned on according to the control signal SCCG applied to the gate terminal of the transistors T7 and T9, the constant current generator data voltage applied to the source terminal of the transistor T7 is input to the internal compensation circuit 50.

Since the voltage of the gate terminal of the driving transistor T8 is fully turned on by applying an initial voltage Vinitial, the input constant current generator data voltage is applied to the gate terminal of the driving transistor T8 while sequentially passing through the transistor T7, the driving transistor T8, and the transistor T9.

The voltage of the gate terminal of the driving transistor T8 may rise up to a voltage corresponding to the sum of the constant current generator data voltage and the threshold voltage of the driving transistor T8, rather than rising to the input constant current generator data voltage.

This means that when the constant current generator data voltage is initially applied to the internal compensation circuit 50, the voltage at the gate terminal of the drive transistor T8 is in a low state, so that the drive transistor T8 is fully turn-on, so that the current flows sufficiently so that the voltage at the gate terminal of the drive transistor T8 rises smoothly, but the higher the voltage at the gate terminal of the drive transistor T8, the smaller the voltage difference between the gate terminal of the drive transistor T8 and the source terminal of the drive transistor T8, and the lower the flow of current, which in turn reduces the flow of current, resulting in a decrease in the flow of current. So, when the voltage difference between the gate terminal and the source terminal of the drive transistor T8 reaches the threshold voltage of the drive transistor T8, the drive transistor T8 is turned off and the flow of current stops.

Since the constant current generator data voltage is applied to the source terminal of the driving transistor T8, the voltage of the gate terminal of the driving transistor T8 rises only to the sum of the threshold voltage of the driving transistor T8. As such, the threshold voltage of the driving transistor T8 may be compensated by the internal compensation circuit 50.

A configuration and operation of the internal compensation circuit of the PWM circuit 111 are similar to the internal compensation circuit of the constant current generator circuit 112, and a duplicate description will be omitted.

As described above, according to an embodiment of the disclosure, the constant current generator circuit 112 automatically compensates the threshold voltage of the driving transistor T8 during setting (or applying) the applied constant current generator data voltage to the gate terminal of the driving transistor T8, which is also the same as the PWM circuit 111.

The term “internal compensation” indicates that the threshold voltages of the driving transistors T8 and T3 are compensated by themselves within the sub-pixel circuit 110 during operation of the sub-pixel circuit 110, and such an internal compensation scheme is distinguished from an external compensation scheme for sensing the current flowing through the driving transistor and compensating for the data voltage based on the sensing result so as to compensate for the threshold voltage Vth or mobility μ deviation of the driving transistor.

Since the threshold voltage of the driving transistor T3 of the constant current generator circuit 112 is internally compensated, according to an embodiment of the disclosure, a constant current generator data voltage may be collectively applied to all pixels (or all sub-pixels) included in the display panel 100. Accordingly, it is possible to sufficiently secure a light-emitting section during one image frame time. This is a difference between an external compensation scheme in which pixels included in the display panel are sequentially scanned for each line so that a constant current generator data voltage having a compensated threshold voltage must be separately applied for each line.

The PWM data voltage in the example of FIGS. 4A and 4B, for gray level representation of each pixel, is sequentially applied to the pixels (or sub-pixels) included in the display panel 100 for each line.

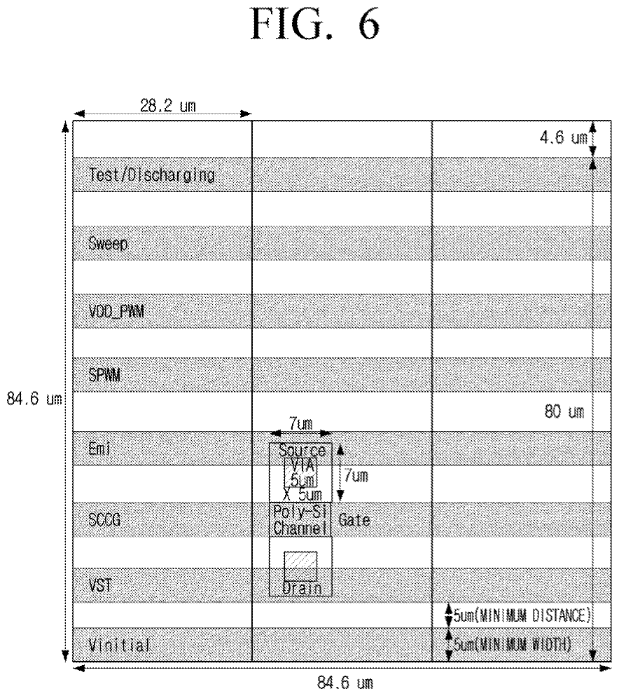

FIG. 6 is a diagram for explaining a problem related to a pixel density. Hereinafter, pixel per inch (PPI) will be used as an index indicating the pixel density.

In order to realize a high-PPI display panel, it is advantageous as the number of transistors or control signal lines included in the TFT backplane decreases.

For example, in order to drive the sub-pixel circuit 110 illustrated in FIG. 4A, a minimum of eight control signal lines are required to apply the driving voltage VDD_PWM and the gate signals TEST/Discharging, Sweep, SPWM, Emi, SCCG, VST, Vinitial to the sub-pixel circuit 110.

At this time, considering the minimum line width of 5 μm of the control signal lines and the minimum spacing of 5 μm between the control signal lines, a space of at least 80 μm is required to implement the control signal lines.

Accordingly, when designing a pixel layout of a high PPI such as, for example, 300 PPI, the sub-pixel circuit 110 shown in FIG. 4A is impossible because it is impossible to position the source and drain arrangements of the transistor within 5 um, which is a separation width between the control signal lines, as shown in FIG. 6, and because there is no space for arranging the capacitors C1 and C2.

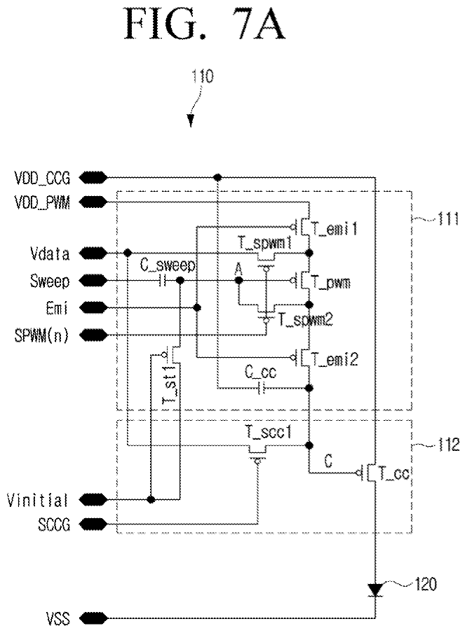

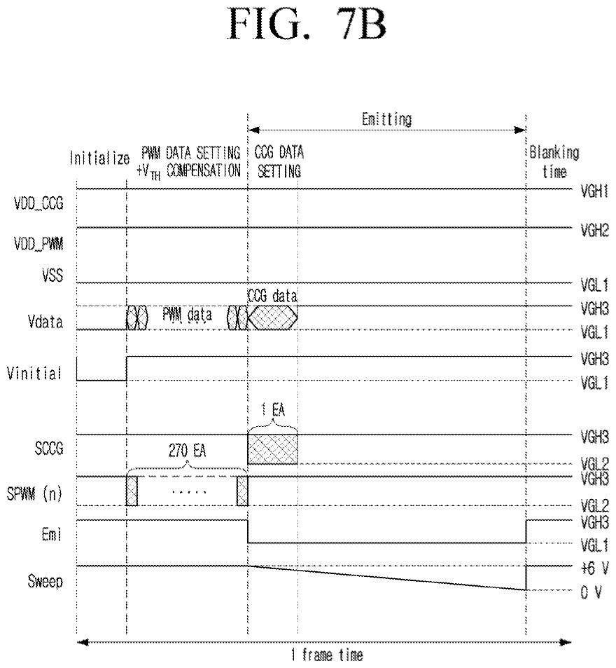

Hereinafter, various examples of sub-pixel circuits using fewer transistors and fewer control signals than the sub-pixel circuit 110 shown in FIG. 4A will be described with reference to FIGS. 7A to 9B. In the description of FIGS. 7A to 9B, description overlapping with the foregoing description will be omitted.

FIG. 7A is a detailed circuit diagram of the sub-pixel circuit 110 according to an embodiment of the disclosure. Referring to FIG. 7A, the sub-pixel circuit 110 may include the constant current generator circuit 112 and the PWM circuit 111.

Specifically, the PWM circuit 111 includes a driving transistor T_pwm. The PWM circuit 111 also includes an internal compensation circuit T_spwm1, T_spwm2. When the PWM data voltage is applied through the source terminal of the transistor T_spwm1 while the transistors T_spwm1 and T_spwm2 are turned on according to the control signal SPWM(n), the PWM circuit 111 applies a voltage corresponding to the sum of the PWM data voltage and the threshold voltage of the driving transistor T_pwm to the gate terminal A node of the driving transistor T_pwm through the turned-on driving transistor T_pwm and the transistors T_spwm1 and T_spwm2.

The PWM data voltage may be a voltage within voltage ranges greater than or equal to the sum of the driving voltage VDD_PWM and the threshold voltage Vth of the driving transistor T_pwm. Therefore, in the case where the PWM data voltage is a voltage corresponding to the full black gray level, the driving transistor T3 maintains an OFF state while the PWM data voltage is set to the gate terminal of the driving transistor T_pwm.

The constant current generator circuit 112 includes a driving transistor T_cc. When the constant current generator data voltage is applied while the transistor T_scc1 is turned on according to the control signal SCCG, the constant current generator circuit 112 applies the constant current generator data voltage to the gate terminal C node of the driving transistor T_cc through the turned-on transistor T_scc1. Unlike the sub-pixel circuit 110 of FIG. 4A, the constant current generator circuit 112 does not include an internal compensation circuit.

The transistor T-emi1 is turned on and off according to the control signal Emi and electrically connects or disconnects the driving voltage VDD_PWM to or from the PWM circuit 111.

The transistor T-emi2 is turned on and off according to a control signal Emi and electrically connects or disconnects the PWM circuit 111 to or from the constant current generator circuit 112.

The capacitor C_sweep receives a sweep voltage Sweep, which is a voltage that sweeps between two different voltages.

The transistor T_st1 is turned on according to the control signal Vinitial to apply the initial voltage Vinitial to the gate terminal (node A) of the driving transistor T_pwm.

The anode terminal of the inorganic light-emitting element 120 is connected to the drain terminal of the driving transistor T_cc, and the cathode terminal of the inorganic light-emitting element 120 is connected to the ground voltage VSS terminal.

Unlike the sub-pixel circuit 110 of FIG. 4A, the sub-pixel circuit 110 of FIG. 7A does not include a transistor corresponding to the transistor T13 for checking whether the sub-pixel circuit 110 is abnormal or discharging the charge remaining on the inorganic light-emitting element 120.

FIG. 7B is a timing diagram of various signals for driving the sub-pixel circuit of FIG. 7A according to an embodiment of the disclosure. Referring to FIG. 7B, the sub-pixel circuit 110 may be driven in the order of an initialization period, a data voltage setting and a threshold voltage compensation period, and an emitting period, during one image frame time.

The initialization period is a period for initializing the voltage of the gate terminal A node of the driving transistor T_pwm. The sub-pixel circuit 110 initializes the gate terminal voltage of the driving transistor T_pwm to the initial voltage Vinitial in the initialization period.

The data voltage setting and threshold voltage compensation period is a period for setting the data voltage in the PWM circuit 111 and the constant current generator circuit 112.

At this time, the data voltage setting and threshold voltage compensation period of FIG. 7B may include a PWM data voltage setting and a threshold voltage compensation period (PWM data setting+Vth compensation) of the driving transistor T_pwm and a constant current generator (CCG) data voltage setting period CCG data setting.

As described above in FIG. 7A, since the constant current generator circuit 112 does not include the internal compensation circuit, as shown in FIG. 7B, the threshold voltage of the driving transistor T_cc is not compensated, and only the constant current generator data voltage is set to the gate terminal of the driving transistor T_cc in the constant current generator data voltage setting period (CCG data setting).

Referring to FIG. 7B, at the same time when the constant current generator data voltage setting period (CCG data setting) starts, a light emitting period starts. That is, the control signal Emi and the sweep voltage Sweep are applied to the sub-pixel circuit 110 at the same time with the application of the control signal SCCG. Accordingly, in the embodiment of FIGS. 7A and 7B, the inorganic light-emitting element 120 emits light at the same time as the constant current generator data voltage is applied to the gate terminal C node of the driving transistor T_cc.

If the control signal Emi and the sweep voltage Sweep are applied after the constant current generator data voltage setting period CCG data setting is completed, the black gray scale cannot be expressed under the structure of the sub-pixel circuit 110 as shown in FIG. 7A representing the gray level through PWM driving, so it may be desirable to drive as FIG. 7B in the circuit structure as FIG. 7A.

The control signal SCCG as shown in FIG. 7B, unlike the control signal SPWM(n), may be applied in batches to all pixels (or all sub-pixels) included in the display panel 100. Thus, in the embodiments of FIGS. 7A and 7B, a constant current generator data voltage may be applied in batches to all pixels (or sub-pixels) included in the display panel 100. On the other hand, as shown in FIG. 7B, the control signal SCCG may be applied collectively to all pixels (or all sub-pixels) included in the display panel 100, unlike the control signal SPWM(n). Thus, in the embodiment of FIGS. 7A and 7B, the constant current generator data voltage may be applied collectively to all pixels (or sub-pixels) included in the display panel 100. The constant current generator data voltage applied to each pixel may be the same voltage for each sub-pixel, but is not limited thereto.

The emitting period is a period in which the inorganic light-emitting element 120 emits light. During the light-emitting period, the inorganic light-emitting element 120 expresses gray level by emitting light according to the magnitude of driving current and duration provided by the sub-pixel circuit 110.

Specifically, since the transistors T_emi1 and T_emi2 are turned on according to the control signal Emi during the light emitting period, the constant current generator circuit 112 and the PWM circuit 111 are electrically connected to each other.

When the emitting period starts, the driving voltage VDD_CCG is applied to the inorganic light-emitting element 120 through the driving transistor T_cc turned on according to the application of the constant current generator data voltage.

Accordingly, when the emitting period starts, the driving current flows through the inorganic light-emitting element 120, and the inorganic light-emitting element 120 starts emitting light. At this time, the driving current for emitting the inorganic light-emitting element 120 has a magnitude corresponding to the constant current generator data voltage.

During the emitting period, a sweep voltage Sweep that linearly sweeps between two different voltages is coupled through the capacitor C_sweep and applied to the gate terminal node A of the driving transistor T_pwm. Accordingly, the voltage of the gate terminal of the driving transistor T_pwm changes according to the sweep voltage.

Accordingly, when the voltage between the source terminal and the gate terminal of the driving transistor T_pwm reaches the threshold voltage of the driving transistor T_pwm, the driving transistor T_pwm is turned from an off state to an on state.

When the driving transistor T_pwm is turned on, the driving voltage VDD_PWM is transmitted to the gate terminal C node of the driving transistor T_cc through the turned-on transistors T_emi1 and T_emi2 and the turned-on driving transistor T_pwm according to the control signal Emi.

When the driving voltage VDD_PWM is applied to the gate terminal of the driving transistor T_cc, the driving transistor T_cc is turned off, and no more driving current flows through the inorganic light-emitting element 120, so that light emitting of the inorganic light-emitting element 120 comes to an end.

As described above, the PWM circuit 111 may PWM drive the inorganic light-emitting element 120 by controlling the time when the driving current flows through the inorganic light-emitting element 120, that is, the duration of the driving current based on the PWM data voltage.

In the embodiment of FIGS. 7A and 7B, the threshold voltage of the driving transistor T_cc of the constant current generator circuit 112 is not compensated. However, since there is no effect due to the deviation of the driving transistor T_cc in one small display panel rather than forming one display panel by combining the plurality of display panels, the embodiment described in FIGS. 7A and 7B may be sufficiently used.

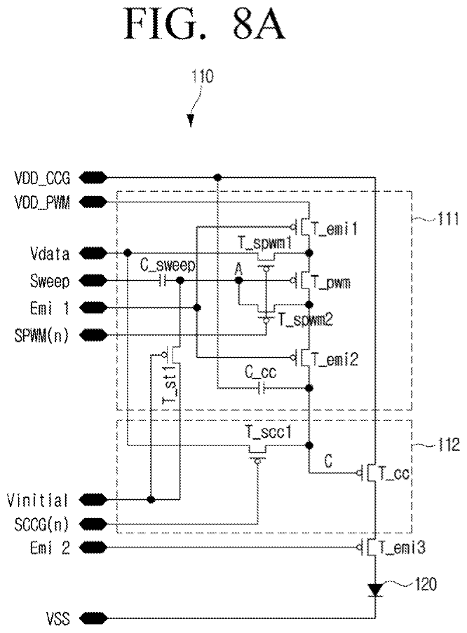

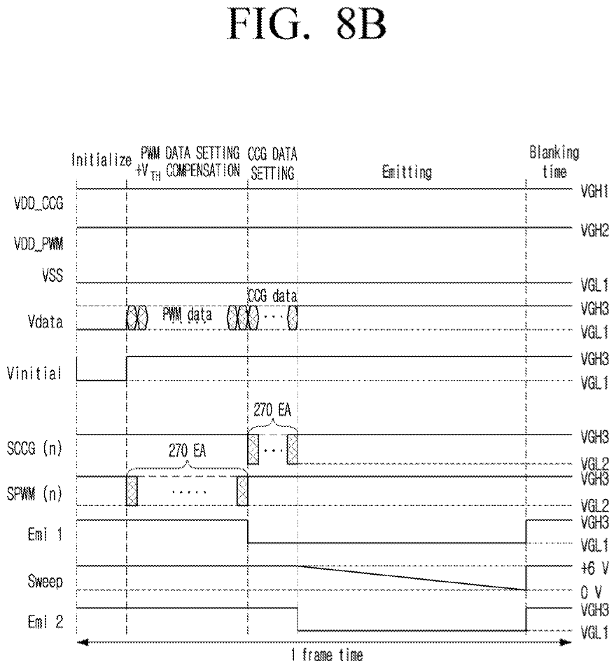

Hereinafter, an embodiment of compensating for a deviation in electrical characteristics of the driving transistor T_cc of the constant current generator circuit 112 in the structure of the sub-pixel circuit 110 as shown in FIGS. 7A and 7B will be described with reference to FIGS. 8A and 8B.

According to an embodiment of the disclosure, a constant current generator data voltage to which a pre-stored compensation value is reflected may be applied to the constant current generator circuit 112.

Specifically, when the display device including the display panel 110 is manufactured, a test image having the same gray level (e.g., a full white gray level) value may be displayed on the display panel 100, and the luminance value for each pixel may be calculated based on the captured image after the image is captured by the image capturing device such as a camera.

A threshold voltage compensation value of the driving transistor T_cc for each pixel may be calculated based on the calculated luminance value for each pixel, and the calculated compensation value may be stored in the display device.

Accordingly, when the constant current generator data voltage is applied to the sub-pixel circuit 110, the threshold voltage of the driving transistor T_cc of the constant current generator circuit 112 may be compensated by reflecting the pre-stored compensation value.

In this way, a method of compensating for deviation among pixels by calculating and pre-storing a compensation value based on an image captured by a camera when manufacturing a display panel and applying the stored compensation value to a data voltage is called “LED calibration method”.

FIGS. 8A and 8B illustrate an embodiment in which the LED calibration method is applied in the structure of the sub-pixel circuit 110 as shown in FIGS. 7A and 7B.

FIG. 8A is a detailed circuit diagram of the sub-pixel circuit 110 according to an embodiment of the disclosure. The sub-pixel circuit 110 of FIG. 8A is the same as the sub-pixel circuit 110 of FIG. 7A, except that the transistor T_emi3 is added between the driving transistor T_cc and the inorganic light-emitting element 120.

FIG. 8B is a timing diagram of various signals to drive a sub-pixel circuit of FIG. 8A according to an embodiment.

According to the above-described LED calibration method, a compensation value may be different for each driving transistor T_cc of each sub-pixel circuit 110 included in the display panel 100. Accordingly, a different constant current generator data voltage may be applied to each sub-pixel circuit 110.

To this end, unlike the timing diagram shown in FIG. 7B, the constant current generator data voltage must be sequentially applied for each row line. Vdata and SCCG(n) shown in the constant current generator data voltage setting period (CCG data setting) of FIG. 8B indicate this.

In the embodiment of FIG. 8B, since the constant current generator data voltage is sequentially applied to the display panel 100 in the order of row lines, a light emitting period must be started after the constant current generator data voltage is set to all sub-pixel circuits 110 included in the display panel 100.

For this purpose, as shown in FIG. 8A, the transistor T_emi3 is additionally required, and the transistor T_emi3 is turned on according to the control signal Emi2 after the constant current generator data voltage setting period (CCG data setting) is completed, and thus the light emitting period starts.

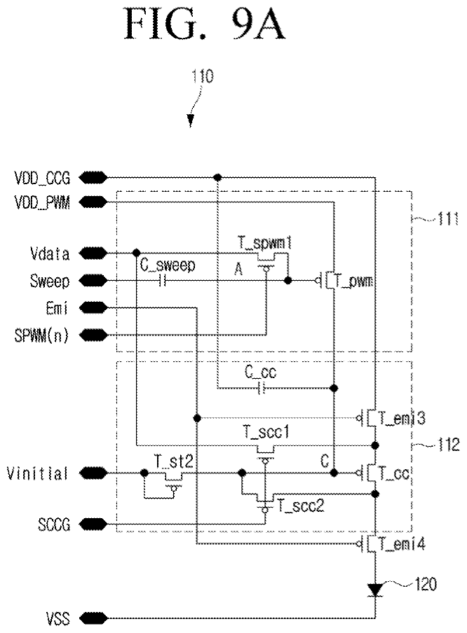

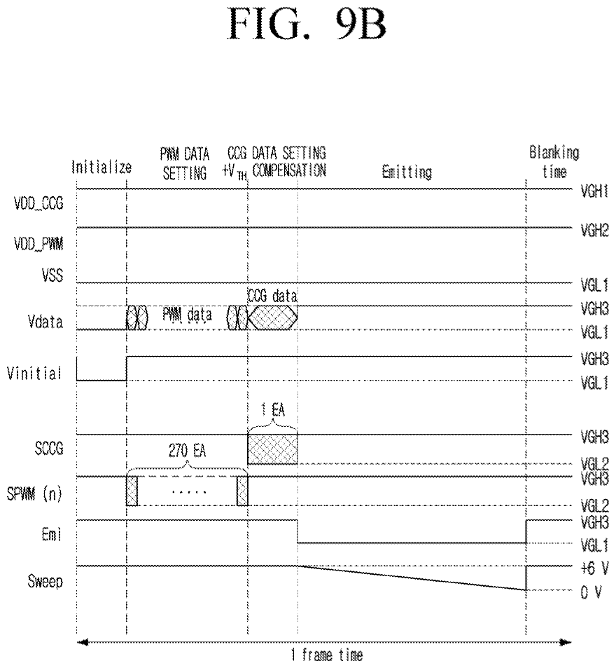

FIG. 9A is a detailed circuit diagram of the sub-pixel circuit 110 according to an embodiment of the disclosure. Referring to FIG. 9A, the sub-pixel circuit 110 may include the constant current generator circuit 112 and the PWM circuit 111.

Specifically, the PWM circuit 111 includes a driving transistor T_pwm. When the PWM data voltage is applied while the transistor T_spwm1 is turned on according to the control signal SPWM(n), the PWM control circuit 111 may apply the PWM data voltage to the gate terminal (A node) of the driving transistor T_pwm through the turned-on transistor T_spwm1. Unlike the sub-pixel circuit 110 of FIG. 4A, the PWM circuit 111 does not include an internal compensation circuit.

The constant current generator circuit 112 includes a driving transistor T_cc. The constant current generator circuit 112 includes internal compensation circuits T_scc1 and T_scc2. When the constant current generator data voltage is applied through the source terminal of the transistor T_scc1 while the transistors T_scc1 and T_scc2 are turned on according to the control signal SCCG, the constant current generator circuit 112 applies the voltage equal to the sum of the constant current generator data voltage and the threshold voltage of the driving transistor T_cc to the gate terminal (node C) of the driving transistor T_cc through the turned-on driving transistor T_cc and the transistors T_scc1, T_scc2.

At this time, the constant current generator data voltage may be a voltage within a voltage range of less than a sum of the driving voltage VDD_CCG and the threshold voltage Vth of the driving transistor T_cc. Accordingly, the driving transistor T_cc maintains the turned-on state while the constant current generator data voltage is set to the gate terminal of the driving transistor T_cc.

The transistor T_emi3 is turned on/off according to the control signal Emi to electrically connect or disconnect the driving voltage VDD_CCG to or from the constant current generator circuit 112.

The transistor T_emi4 is turned on/off according to the control signal Emi to electrically connect or disconnect the constant current generator circuit 112 to or from the inorganic light-emitting element 120.

The capacitor C_sweep receives a sweep voltage Sweep, which is a voltage that sweeps between two different voltages.

The transistor T_st2 is turned on according to the control signal Vinitial to apply the initial voltage Vinitial to the gate terminal (node C) of the driving transistor T_cc.

The anode terminal of the inorganic light-emitting element 120 is connected to the drain terminal of the transistor T_emi4, and the cathode terminal is connected to the ground voltage (VSS) terminal.

Unlike the sub-pixel circuit 110 of FIG. 4A, the sub-pixel circuit 110 of FIG. 9A does not include a transistor corresponding to the transistor T13 for checking whether the sub-pixel circuit 110 is abnormal or discharging the charge remaining on the inorganic light-emitting element 120.

FIG. 9B is a timing diagram of various signals for driving the sub-pixel circuit of FIG. 9A according to an embodiment of the disclosure. Referring to FIG. 9B, the sub-pixel circuit 110 may be driven in the order of an initialization period, a data voltage setting and threshold voltage compensation period, and an emitting period, during one image frame time.

The initialization period is a period for initializing the voltage of the gate terminal C node of the driving transistor T_cc. The sub-pixel circuit 110 initializes the gate terminal voltage of the driving transistor T_cc to the initial voltage Vinitial in the initialization period.

The data voltage setting and the threshold voltage compensation period are periods for setting data voltage to the PWM circuit 111 and the constant current generator circuit 112.

The data voltage setting and threshold voltage compensation period of FIG. 9B may include a PWM data voltage setting period (PWM data setting), and a threshold voltage compensation period (CCG data setting+Vth compensation) of the constant current generator data voltage setting and driving transistor T_cc.

As described above with reference to FIG. 9A, since the PWM circuit 111 does not include the internal compensation circuit, as shown in FIG. 9B, the PWM data voltage setting period (PWM data setting) does not compensate for the threshold voltage of the driving transistor T_pwm, and only the PWM data voltage is set to the gate terminal of the driving transistor T_pwm.

According to an embodiment of the disclosure, a PWM data voltage to which a pre-stored compensation value is reflected may be applied to the PWM circuit 111.

More specifically, when the display device including the display panel 110 is manufactured, a test image having the same gray level (e.g., a full white gray level) value is displayed on the display panel 100, and the luminance value for each pixel may be calculated based on the captured image after capturing through an image capturing device such as a camera.

The threshold voltage compensation value of the driving transistor T_pwm for each pixel may be calculated based on the calculated luminance value for each pixel, and the calculated compensation value may be stored in the display device.

Accordingly, when the PWM data voltage is applied to the sub-pixel circuit 110, the threshold voltage of the driving transistor T_pwm of the PWM circuit 111 may be compensated by reflecting the previously stored compensation value.

When there is no internal compensation circuit in the PWM circuit 111 as shown in FIG. 9A, the LED calibration method may be applied to compensate the threshold voltage of the driving transistor T_pwm of the PWM circuit 111.

As shown in FIG. 9B, the control signal SCCG may be applied collectively to all pixels (or all sub-pixels) included in the display panel 100, unlike the control signal SPWM(n). In the embodiment of FIGS. 9A and 9B, the constant current generator data voltage may be applied collectively to all pixels (or sub-pixels) included in the display panel 100. In this case, the constant current generator data voltage applied to each pixel may be the same voltage for each sub-pixel, but is not limited thereto.

The light emitting period is an interval in which the inorganic light-emitting element 120 emits light. During the light-emitting period, the inorganic light-emitting element 120 emits light according to the magnitude and duration of the driving current provided by the sub-pixel circuit 110.

In detail, since the transistors T_emi3 and T_emi4 are turned on according to the control signal Emi during the light emitting period, the driving voltage VDD_CCG is applied to the inorganic light-emitting element 120 through the driving transistor T_cc already turned on according to the application of the constant current generator data voltage.

Accordingly, when the emitting period starts, the driving current flows through the inorganic light-emitting element 120, and the inorganic light-emitting element 120 starts emitting light. At this time, the driving current for emitting the inorganic light-emitting element 120 has a magnitude corresponding to the constant current generator data voltage.

A sweep voltage (Sweep) linearly sweeping between two different voltages is coupled through the capacitor C_sweep and applied to the gate terminal (A node) of the driving transistor (T_pwm). The voltage of the gate terminal of the driving transistor T_pwm is changed according to the sweep voltage.

Accordingly, when the voltage between the source terminal and the gate terminal of the driving transistor T_pwm reaches the threshold voltage of the driving transistor T_pwm, the driving transistor T_pwm changes from turned-off state to a turned-on state.

When the driving transistor T_pwm is turned on, the driving voltage VDD_PWM is transferred to the gate terminal (node C) of the driving transistor T_cc through the turned on driving transistors T_pwm.

When the driving voltage VDD_PWM is applied to the gate terminal of the driving transistor T_cc, the driving transistor T_cc is turned off, and the driving current does not flow through the inorganic light-emitting element 120, thereby terminating the emission of the inorganic light-emitting element 120.

As described above, the PWM circuit 111 may PWM-drive the inorganic light-emitting element 120 by controlling the time during which the driving current flows through the inorganic light-emitting element 120, that is, the duration of the driving current based on the PWM data voltage.

As described above with reference to FIGS. 7A to 9B, implementation of a display panel of high PPI is possible by implementing the sub-pixel circuit 110 using a smaller number of transistors and a smaller number of control signals than in the embodiments of FIGS. 4A and 4B.

Referring to FIGS. 4A, 7A, 8A, and 9A, separate different driving voltages VDD_CCG, VDD_PWM are applied to the constant current generator circuit 112 and the PWM circuit 111.

If one driving voltage (e.g., VDD) is commonly used for the constant current generator circuit 112 and the PWM circuit 111, the constant current generator circuit 112 using the driving voltage to apply the driving current to the inorganic light-emitting element 120 and the PWM circuit 111 controlling only the pulse width of the driving current through the on/off control of the driving transistor T_pwm may use the same driving voltage VDD, which may cause a problem.

In detail, the actual display panel 100 has a different resistance value for each region. When the driving current flows, a difference between the IR drop values is generated for each region, and differences of the driving voltage VDD may be generated according to the position of the display panel 100.

Accordingly, when the PWM circuit 111 and the constant current generator circuit 112 commonly use the driving voltage VDD, there is a problem that the operation time of the PWM circuit 111 varies for each region of the display panel 100 with respect to the same PWM data voltage. Since the driving voltage VDD is applied to the source terminal of the driving transistor T_pwm, the on/off operation of the driving transistor T_pwm is affected by the change of the driving voltage VDD.

This problem may be solved by applying different driving voltages to each of the constant current generator circuit 112 and the PWM circuit 111 as illustrated in FIGS. 4A, 7A, 8A, and 9A.

That is, when the driving voltage flows, even if the driving voltage VDD_CCG of the constant current generator circuit 112 varies for each region of the display panel 100 as described above, the separate driving voltage VDD_PWM is applied to the PWM circuit 111, and the above-described problem may be solved.

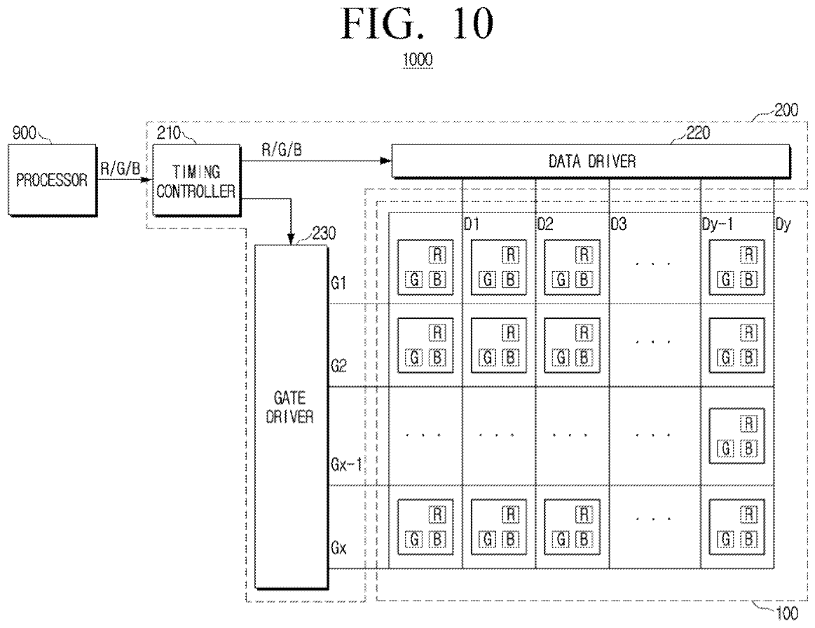

FIG. 10 is a configuration diagram of a display device 1000 according to an embodiment.

Referring to FIG. 10, a display device 1000 includes the display panel 100, the driver 200, and a processor 900.

The display panel 100 includes a plurality of pixels, each of which includes a plurality of sub-pixels.

The display panel 100 may be formed in a matrix shape so that the gate lines (G1 to Gx) and the data lines (D1 to Dy) intersect each other, and each pixel may be formed in a region provided by the intersection.

Each pixel may include three sub-pixels such as R, G, and B, and each sub-pixel included in the display panel 100 may include the inorganic light-emitting element 120 and the sub-pixel circuit 110 of a corresponding color, as described above.

The data lines (D1 to Dy) are lines for applying a data voltage (e.g., a constant current data voltage, a PWM data voltage) to each sub-pixel included in the display panel 100, and the gate lines (G1 to Gx) are lines for selecting pixels (or sub-pixels) included in the display panel 100 by lines. The data voltage applied through the data lines (D1 to Dy) may be applied to the pixel (or sub-pixel) of the selected row line through the gate signal

According to an embodiment, each data line (D1 to Dy) may be applied with the data voltage to be applied to the pixel associated with each data line. As a single pixel includes a plurality of sub-pixels (e.g., R, G, B sub-pixels), the data voltage (that is, R data voltage, G data voltage, and B data voltage) to be applied to each of the R, G, B sub-pixels included in a single pixel may be time-divided and applied to each sub-pixel through one data line. Data voltages that are time-divided and applied through a single data line as above may be applied to each sub-pixel through the MUX circuit.

According to an embodiment, a separate data line may be provided for each R, G, and B sub-pixels. In this example, the R data voltage, the G data voltage, and the B data voltage need not be time-divided and applied, and a corresponding data voltage may be applied to the corresponding sub-pixel simultaneously through each data line.

Referring to FIG. 10, for convenience of illustration, only one set of gate lines, such as G1 to Gx, is shown. However, the number of the actual gate lines may vary depending on the driving method of the sub-pixel circuit 110 included in the display panel 100.

The driver 200 may drive the display panel 100 according to the control of the processor 900, and may include a timing controller 210, a data driver 220, and the scan driver 230, or the like.

The timing controller 210 may receive from the outside an input signal (IS), horizontal synchronous signal (Hsync), vertical synchronous signal (Vsync), and main clock signal (MCLK), or the like, generate an image data signal, a scanning control signal, a data control signal, a light emitting control signal, or the like, and provide the same to the display panel 100, the data driver 220, the gate driver 230, or the like.

The timing controller 210 may be a control signal for selecting the R, G, B sub-pixels, respectively, that is, the MUX signal to the MUX circuit. A plurality of sub-pixels included in the pixels of the display panel 100 may be selected through the MUX circuit, respectively.

The data driver 220 (or source driver) provides the constant current data voltage or PWM data voltage to each sub-pixel circuit 110 of the display panel 100. To this end, the data driver 220 generates a data signal (in particular, PWM data voltage), and may generate the data signal by being forwarded with the image data of the R/G/B component from the processor 900. The data driver 220 may apply the generated data signal to each sub-pixel circuit 110 of the display panel 100 through the data lines (D1 to Dy).

The gate driver 230 (or scan driver) may generate various gate signals (e.g., VST, SCCG, SPWM, Emi, Sweep, etc.) for selecting and driving a pixel arranged in matrix form in a row line unit, and may apply the generated gate signal to the display panel 100 through the gate lines (G1 to Gx).

The driver 200, though not illustrated in the drawings, may include a multiplexer (MUX) circuit for selecting each of the plurality of sub-pixels of different colors, constituting a pixel.

The driver 200 may include a driving voltage providing circuit for providing various driving voltages (VDD_CCG, VDD_PWM), ground voltages (VSS, etc.) to each sub-pixel circuit 110 included in the display panel 100.

The driver 200 may include a clock signal providing circuit for providing various clock signals to a gate driver or a data driver circuit, and may include a sweep signal providing circuit for providing a sweep voltage.

At least some of the various circuits of the driver 200 described above may be implemented with a separate chip form to be mounted on an external printed circuit board (PCB) together with a timing controller (TCON), and may be connected to sub-pixel circuits formed on a thin film transistor (TFT) layer of the display panel 100 through the film on glass (FOG) wiring.

At least some of the various circuits of the driver 200 described above may be implemented in a separate chip form and arranged on a chip on film (COF) form on a film, and may be connected to sub-pixel circuits formed on the TFT layer formed on the display panel 100 through the FOG wiring.

At least some of the various circuits of the driver 200 described above may be implemented with a separate chip form to be arranged on a COG form (that is, arranged on a rear surface (an opposite side of a surface on which the TFT layer is formed with respect to the glass substrate) of the glass substrate (described below) of the display panel 100), and may be connected to the sub-pixel circuits 110 formed on the TFT layer of the display panel 100 through the connection wiring.

At least some of the various circuits of the driver 200 described above may be formed in the TFT layer together with the sub-pixel circuits 110 formed in the TFT layer in the display panel 100 and may be connected to the sub-pixel circuits 110.

For example, among various circuits of the driver 200 described above, the scan driver, the sweep signal providing circuit, and the MUX circuit may be formed in the TFT layer of the display panel 100, the data driver circuit may be arranged on the rear surface of the glass substrate of the display panel 100, and the driving voltage providing circuit, the clock signal providing circuit, and the TCON may be arranged on the external PCB, but is not limited thereto.

The processor 900 controls overall operations of a display device 1000. The processor 900 may drive the display panel 100 by controlling the driver 200.

The processor 900 may be implemented with at least one of a central processing unit (CPU), a micro-controller, an application processor (AP), a communication processor (CP), or an advanced reduced instruction set computing (RISC) machine (ARM) processor.

Referring to FIG. 10, the processor 900 and the timing controller 210 are described as separate components. However, according to an embodiment, only one of the components is included in the display device 1000, and an embodiment in which the included component performs the remaining component function is possible.

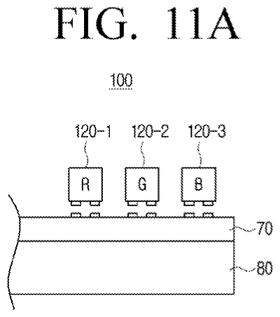

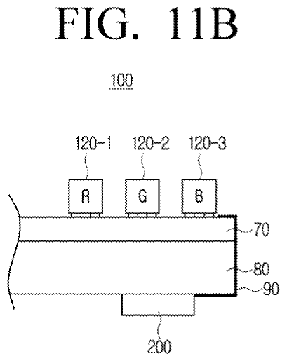

FIG. 11A is a cross-sectional view of the display panel 100 according to an embodiment of the disclosure. In FIG. 11A, only one pixel included in the display panel 100 is illustrated for convenience of description.

Referring to FIG. 11A, the display panel 100 may include a glass substrate 80, a TFT layer 70, and inorganic light-emitting elements R, G, and B 120-1, 120-2, and 120-3. In this case, the aforementioned sub-pixel circuit 110 may be implemented as a thin film transistor (TFT), and may be included in the TFT layer 70 on the glass substrate 80.

Each of the inorganic light-emitting elements R, G, and B 120-1, 120-2, and 120-3 is mounted on the TFT layer 70 so as to be electrically connected to the corresponding sub-pixel circuit 110 to form the aforementioned sub-pixels.

Although not shown in the drawing, the TFT layer 70 includes the sub-pixel circuit 110 providing driving current to the inorganic light-emitting elements 120-1, 120-2 and 120-3 for each of the inorganic light-emitting elements 120-1, 120-2, and 120-3, and each of the inorganic light-emitting elements 120-1, 120-2, 120-3 may be mounted or disposed on the TFT layer 70 so as to be electrically connected to the corresponding sub-pixel circuit 110, respectively.

FIG. 11A illustrates that the inorganic light-emitting elements R, G, and B 120-1, 120-2, and 120-3 are flip chip type micro LEDs, as an example. However, the embodiment is not limited thereto, and the inorganic light-emitting elements R, G, and B 120-1, 120-2, 120-3 may be a horizontal type or a vertical type micro LED according to an embodiment.

FIG. 11B is a cross-sectional view of the display panel 100 according to an embodiment of the disclosure. Referring to FIG. 11B, the display panel 100 may include the TFT layer 70 formed on one surface of a glass substrate 80, and inorganic light-emitting elements R, G, and B 120-1, 120-2, 120-3, the driver 200, and a connection wiring 90 for electrically connecting the sub-pixel circuit 110 formed in the TFT layer 70 and the driver 200.

As described above in FIG. 10, at least some of the various components that may be included in the driver 200 are implemented in the form of a separate chip and disposed on the rear surface of the glass substrate 80, and may be connected to the TFT through the connection wiring 90.

In this regard, referring to FIG. 11B, the pixel circuits 110 included in the TFT layer 70 are electrically connected to the driver 200 through the connection wiring 90 formed on the edge (and/or side) of a TFT panel (hereinafter, the TFT layer 70 and the glass substrate 80 are collectively referred to as a TFT panel).

As described above, the reason for connecting the pixel circuits 110 and the driver 200 included in the TFT layer 70 by forming the connection wiring 90 in the edge region of the display panel 100 is that, when the pixel circuits 110 and the driver 200 are connected to each other by forming a hole penetrating the glass substrate 80, there may be a problem of a crack on the glass substrate 80 due to temperature difference between a process of manufacturing the TFT panels 70, 80 and a process of filling a hole with a conductive material.

An example in which the pixel circuit 110 is implemented in the TFT layer 70 has been described above. However, embodiments are not limited thereto. According to an embodiment of the disclosure, when the pixel circuit 110 is implemented, the pixel circuit chip in the form of a ultra-small microchip may be implemented in sub-pixel units or pixel units without using the TFT layer 70, and may be mounted on the substrate 80.

For example, the display panel 100 may be implemented by disposing, on the substrate 80, an R pixel circuit chip next to the R inorganic light-emitting element 20-1, a G pixel circuit chip next to the G inorganic light-emitting element 20-2, and a B pixel circuit chip next to the B inorganic light-emitting element 20-3, respectively, or disposing or mounting the R, G, and B pixel circuit chips next to the R, G, and B inorganic light-emitting elements 20-1 to 20-3 on the substrate 80.

It has been described that the sub-pixel circuit 110 is implemented as a P-type TFT, but various embodiments above may be applied to the N-type TFT as well.

According to various embodiments, the TFT forming the TFT layer (or the TFT panel) is not limited to a specific structure or type. In other words, the TFT recited in various examples may be implemented as a low temperature poly silicon (LTPS) TFT, an oxide TFT, a poly silicon or a-silicon TFT, an organic TFT, and a graphene TFT, or the like, and may be applied to a P type (or N-type) MOSFET in a Si wafer CMOS process.

The display panel 100 according to various embodiments of the disclosure may be applied to a wearable device, a portable device, a handheld device, as a single unit, and various electronic products or parts requiring a display. The display panel 100 according to various embodiments of the disclosure is applicable, through the assembly arrangement of the plurality of display modules, to a small display device such as a monitor for a personal computer, a TV, or a large display device such as a digital signage, an electronic display, or the like.

As described above, according to various embodiments of the disclosure, it is possible to prevent the wavelength of light emitted by the inorganic light-emitting element included in the display panel from being changed according to the grayscale. It is possible to correct the stain or color of the inorganic light-emitting element constituting the display panel, and even when a large-area display panel is composed by combining the display panels in the form of modules, the difference in luminance or color between each display panel module may be corrected. In addition, a display panel having a high pixel density may be implemented. Accordingly, it is possible to contribute to high quality, miniaturization, and weight reduction of the display panel.

What is claimed is:

1. A display panel in which pixels are arranged in a matrix form, wherein each of the pixels comprises a plurality of sub-pixels, wherein each of the plurality of sub-pixels comprises:
an inorganic light-emitting element;
a constant current generator circuit that provides a driving current to the inorganic light-emitting element based on a constant current generator data voltage; and
a pulse width modulation (PWM) circuit for controlling a time for the driving current to flow through the inorganic light-emitting element based on a PWM data voltage,
wherein the constant current generator circuit comprises a first driving transistor and the PWM circuit comprises a second driving transistor, and
wherein the constant current generator circuit or the PWM circuit comprises an internal compensation circuit that compensates for electrical characteristics of the first driving transistor or the second driving transistor.

2. The display panel of claim 1, wherein the internal compensation circuit comprises:
a first transistor connected between a gate terminal and a drain terminal of the first driving transistor or the second driving transistor; and
a second transistor comprising: a drain terminal connected to a source terminal of the first driving transistor or the second driving transistor; and a gate terminal connected to a gate terminal of the first transistor.

3. The display panel of claim 2, wherein the constant current generator circuit applies, based on the constant current generator data voltage being applied, the constant current generator data voltage to the gate terminal of the first driving transistor,
wherein the PWM circuit comprises the internal compensation circuit,
wherein the PWM circuit applies, based on the PWM data voltage being applied to a source terminal of the second transistor, a compensation voltage to a gate terminal of the second driving transistor, and
wherein the compensation voltage comprises the PWM data voltage in which a threshold voltage of the second driving transistor is compensated through the internal compensation circuit.

4. The display panel of claim 3, wherein the drain terminal of the second driving transistor is connected to the gate terminal of the first driving transistor, and
wherein the PWM circuit controls a time during which the driving current flows through the inorganic light-emitting element by controlling an on and off of the first driving transistor through an operation of the second driving transistor that is on and off based on the compensation voltage and a linearly-changing sweep voltage.

5. The display panel of claim 3, wherein the constant current generator data voltage is comprehensively applied to all pixels included in the display panel, and
wherein the PWM data voltage is applied to pixels arranged in the matrix form in an order of row lines.

6. The display panel of claim 3, wherein the constant current generator data voltage is based on a prestored compensation value for an electric characteristic of the first driving transistor, and is applied to the pixels arranged in the matrix form in an order of row lines, and
wherein the PWM data voltage is applied to the pixels arranged in the matrix form in the order of row lines.

7. The display panel of claim 6, wherein the prestored compensation value is a value calculated based on a luminance value for each pixel of the display panel measured based on a test image displayed on the display panel and captured through an image capturing device.

8. The display panel of claim 2, wherein the constant current generator circuit comprises the internal compensation circuit,
wherein the constant current generator circuit applies, based on the constant current generator data voltage being applied to a source terminal of the second transistor, a compensation voltage to the gate terminal of the first driving transistor,
wherein the compensation voltage comprises the constant current generator data voltage in which a threshold voltage of the first driving transistor is compensated through the internal compensation circuit, and
wherein the PWM circuit applies, based on the PWM data voltage being applied, the applied PWM data voltage to a gate terminal of the second driving transistor.

9. The display panel of claim 8, wherein a drain terminal of the second driving transistor is connected to the gate terminal of the first driving transistor,
wherein the constant current generator circuit provides, to the inorganic light-emitting element, the driving current of a size corresponding to a difference value between a driving voltage applied to the source terminal of the first driving transistor and the compensation voltage, and
wherein the PWM circuit controls the time during which the driving current flows through the inorganic light-emitting element by controlling an on and off of the first driving transistor through an operation of the second driving transistor that is on and off based on the PWM data voltage and a linearly-changing sweep voltage.

10. The display panel of claim 9, wherein the constant current generator data voltage is comprehensively applied to all the pixels included in the display panel, and
wherein the PWM data voltage is applied to the pixels arranged in the matrix form in an order of row lines.

11. The display panel of claim 8, wherein the PWM data voltage is based on a prestored compensation value for an electric characteristic of the second driving transistor.

12. The display panel of claim 11, wherein the prestored compensation value is a value calculated based on a luminance value for each pixel of the display panel measured based on a test image displayed on the display panel and captured through an image capturing device.

13. The display panel of claim 1, wherein a pixel density of the display panel is greater than or equal to 100 pixels per inch.
